(19) United States
(12) Patent Application Publication
(10) Pub. No.: US 2026/0084546 A1
(43) Pub. Date: Mar. 26, 2026

(54) MULTI-GEARED OR CVT-BASED SYNCHRONOUS RELUCTANCE MACHINE POWERTRAIN ARCHITECTURE

(71) Applicants: Philip KORTA, Troy, MI (US); Lakshmi Varaha IYER, Troy, MI (US); Shruthi MUKUNDAN, Troy, MI (US); MAGNA INTERNATIONAL INC., Aurora (CA)

(72) Inventors: Philip KORTA, Troy, MI (US); Lakshmi Varaha IYER, Troy, MI (US); Shruthi MUKUNDAN, Troy, MI (US)

(21) Appl. No.: 19/108,560

(22) PCT Filed: Aug. 31, 2023
(86) PCT No.: PCT/US2023/031585

§ 371 Date: Mar. 4, 2025

Related U.S. Application Data
(60) Provisional application No. 63/404,233, filed on Sep. 7, 2022.

(51) Int. Cl. B60L 15/20

(52) U.S. Cl. CPC B60L 15/2054; B60L 15/2045; B60L 2240/421; B60L 2240/461; B60L 2240/463; B60L 2240/486

(57) ABSTRACT

A powertrain system for a vehicle includes a synchronous reluctance machine having a rotor defining a plurality of circumferentially-spaced regions having relatively low reluctance interspaced with regions having relatively high reluctance. A transmission is operatively disposed between the synchronous reluctance machine and one or more wheels. A controller is configured to: determine, for given values of axle torque and output speed, a plurality of different sets of values for a gear ratio of the transmission and for motor speed of the synchronous reluctance machine; determine an optimal set of the plurality of different sets of values for a gear ratio of the transmission and for motor speed of the synchronous reluctance machine; and operate the synchronous reluctance machine and the transmission in accordance with the optimal set of values for a gear ratio of the transmission and for motor speed of the synchronous reluctance machine.

### CROSS-REFERENCE TO RELATED APPLICATIONS

This PCT International Patent application claims the benefit of and priority to U.S. Provisional Patent Application Ser. No. 63/404,233, filed Sep. 7, 2022, titled “Multi-Geared Or CVT-Based Synchronous Reluctance Machine Powertrain Architecture,” the entire disclosure of which is hereby incorporated by reference in its entirety.

### FIELD

The present disclosure relates generally to a powertrain architecture for vehicles. More specifically, the present disclosure relates to a powertrain architecture that includes a synchronous reluctance machine and a multi-geared transmission or a continuously variable transmission (CVT).

### BACKGROUND

Increasing costs of permanent magnet materials are directing research and industry interests towards machine technologies for electric vehicle traction applications and that do not require rare earth magnets. Synchronous reluctance machines (SynRM) are a well-established machine architecture that take advantage of a high saliency ratio in the absence of field excitation and/or magnets to generate torque using the reluctance component of the torque equation. SynRM technology offers a low-cost solution since it does not require copper field windings or magnets to be inserted into the rotor in comparison to other synchronous machine topologies such as wound field synchronous machines (WFSM) or permanent magnet synchronous machines (PMSM). In the absence of a field excitation, the SynRM suffers by not being able to provide an extended continuous power region and a competitive efficiency.

### SUMMARY

The present disclosure provides a method for controlling a powertrain in a vehicle having a synchronous reluctance machine coupled to drive one or more wheels via a transmission. The method comprises: determining, for given values of axle torque and output speed, a plurality of different sets of values for a gear ratio of the transmission and for motor speed of the synchronous reluctance machine; determining an optimal set of the plurality of different sets of values for a gear ratio of the transmission and for motor speed of the synchronous reluctance machine; operating the synchronous reluctance machine in accordance with the optimal set of values for the motor speed; and operating the transmission in accordance with the optimal set of values for the gear ratio.

The present disclosure also provides a powertrain system for a vehicle. The powertrain system includes: a synchronous reluctance machine having a rotor defining a plurality of circumferentially-spaced regions having relatively low reluctance interspaced with regions having relatively high reluctance. The powertrain system also includes a transmission operatively disposed between the synchronous reluctance machine and one or more wheels. The powertrain system also includes a controller, which is configured to: determine, for given values of axle torque and output speed, a plurality of different sets of values for a gear ratio of the transmission and for motor speed of the synchronous reluctance machine; determine an optimal set of the plurality of different sets of values for a gear ratio of the transmission and for motor speed of the synchronous reluctance machine; and operate the synchronous reluctance machine and the transmission in accordance with the optimal set of values for a gear ratio of the transmission and for motor speed of the synchronous reluctance machine.

### BRIEF DESCRIPTION OF THE DRAWINGS

Further details, features and advantages of designs of the invention result from the following description of embodiment examples in reference to the associated drawings.

FIG. 1 shows a fragmentary cut-away side view of a first synchronous reluctance machine, in accordance with the present disclosure;

FIG. 2 shows a fragmentary cut-away side view of a second synchronous reluctance machine, in accordance with the present disclosure;

FIG. 3 shows a graph illustrating torque-speed characteristics of the second synchronous reluctance machine, in accordance with the present disclosure;

FIG. 4. shows a fragmentary cut-away side view of a third synchronous reluctance machine, in accordance with the present disclosure;

FIG. 5 shows a graph illustrating torque-speed characteristics of the third synchronous reluctance machine, in accordance with the present disclosure;

FIG. 6 shows a schematic block diagram of a vehicle having a powertrain system including a synchronous reluctance machine coupled to drive a set of wheels via a transmission, in accordance with the present disclosure;

FIG. 7 shows a schematic block diagram of a first powertrain system including a continuously variable transmission (CVT), in accordance with the present disclosure;

FIG. 8 shows a schematic block diagram of a second powertrain system including a multi-geared transmission, in accordance with the present disclosure;

FIG. 9 shows a graph illustrating torque-speed characteristics of a powertrain system including a synchronous reluctance machine coupled to a multi-geared transmission, in accordance with the present disclosure;

FIG. 10 shows a graph illustrating torque-speed characteristics of a powertrain system including a synchronous reluctance machine coupled to a CVT, in accordance with the present disclosure;

FIG. 11 shows a graph illustrating power-speed characteristics of a powertrain system including a synchronous reluctance machine coupled to a CVT, in accordance with the present disclosure;

FIG. 12 shows a graph illustrating motor efficiency characteristics of a powertrain system including a synchronous reluctance machine coupled to each of a multi-geared transmission and a CVT, in accordance with the present disclosure;

FIG. 13 shows a graph illustrating motor efficiency vs. gear ratio characteristics of a powertrain system including a synchronous reluctance machine coupled to a transmission, in accordance with the present disclosure;

FIG. 14 shows a graph illustrating efficiencies obtained by selecting gear ratios for gest efficiency in powertrain systems including a synchronous reluctance machine coupled to each of a multi-geared transmission and a CVT, in accordance with the present disclosure; and

FIG. 15 shows a flow chart of steps in a method for controlling a powertrain in a vehicle, in accordance with some embodiments of the present disclosure.

### DETAILED DESCRIPTION

Referring to the drawings, the present invention will be described in detail in view of following embodiments. It is an objective of the system and method of the present disclosure to provide a system using a multi-gear or continuously variable transmission system to enhance a constant power region of a synchronous reluctance machine. It is also an objective of the system and method of the present disclosure apply a gear ratio control methodology to also increase the drive-cycle efficiency.

The systems and methods of the present disclosure aim to address drawbacks of a synchronous reluctance machine (SynRM), which may also be called a synchronous reluctance motor, by using a multi-gear or continuously variable transmission (CVT). The function of the gear ratio in the transmission is to rescale the axle torque and speed to a range that is suitable for the electric machine. The motor torque Tₚ is related to the torque at the wheel T_{w} as described in equation (1), below, where i_{g} is the gear ratio and n is the driveline efficiency. The output motor speed Nₚ is also a function of the gear ratio i_{g} and the wheel speed N_{w}, as described in equation (2), below.

$$\begin{matrix}{T}_{p} = \frac{{T}_{w}}{{i}_{g} η} & ( 1 ) \\ {N}_{p} = {i}_{g} {N}_{w} & ( 2 )\end{matrix}$$

The systems and methods of the present disclosure may provide several advantages over conventional systems. For example, Multi-geared or CVT electric powertrains can achieve higher peak torque at low speeds and offer extended field-weakening regions through selection of appropriate gear ratios. Multi-gear or CVT transmissions can increase the efficiency of the SynRM by controlling the applied gear ratio at varying load conditions of torque and speed. A SynRM coupled to a Multi-gear or CVT may provide enhanced efficiency and constant power performance when compared to a fixed gear SynRM. When combined with a multi-gear or CVT transmission, the SynRM may provide a competitive alternative to wound field synchronous machines (WFSM) or permanent magnet synchronous machines (PMSM). A powertrain system as provided in the present disclosure may also be very attractive for agriculture applications, such as in tractors and other machinery, as well.

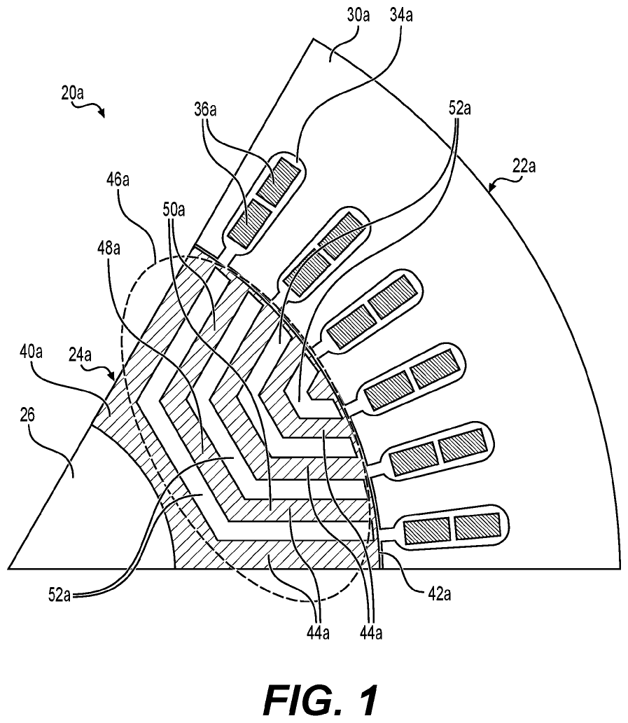

FIG. 1 shows a fragmentary cut-away side view of a first synchronous reluctance machine 20a, including a first stator 22a having a tubular shape and disposed annularly around a first rotor 24a. The first stator 22a includes a first stator core 30a, which may be made of metal laminations. The first stator core 30a defines a series of first teeth 32a at regular circumferential intervals, with each of the first teeth 32a extending radially inwardly and defining first slots 34a for receiving first stator windings 36a between adjacent ones of the first teeth 32a. Each of the first slots 34a includes two sets of the first stator windings 36a. However, different winding arrangements may be used.

The first rotor 24a has a generally cylindrical shape attached to a motor shaft 26 and coaxial with the first stator 22a. The first rotor 24a includes a first rotor core 40a having a cylindrical shape defining first a peripheral edge 42a. The first rotor core 40a defines a plurality of first arch-shaped structures 44a in nested groups 46a disposed at regular angular intervals of 60-degrees apart from one another. Only one of the nested groups 46a of the first arch-shaped structures 44a is shown in the fragmentary view of FIG. 1. However, the first rotor core 40a of the first rotor a may include several of the nested groups 46a of the first arch-shaped structures 44a, such as four, six, or eight of the nested groups of the first arch-shaped structures 44a.

Each of the nested groups 46a includes four of the first arch-shaped structures 44a in a nested arrangement, with a center section 48a extending in a flat line tangential to an annular ring within the first rotor 24a. Each of first arch-shaped structures 44a also includes two wing portions 50a attached to respective ends of the center section 48a and each extending generally radially outward toward the peripheral edge 42a of the first rotor core 40a. The first rotor core 40a also defines first arch-shaped recesses 52a between adjacent ones of the first arch-shaped structures 44a. Together, the first arch-shaped structures 44a and the first arch-shaped recesses 52a define a plurality of circumferentially-spaced regions having relatively low reluctance interspaced with regions having relatively high reluctance. These circumferentially-spaced regions having relatively low reluctance interspaced with regions having relatively high reluctance may interact with a magnetic field generated by windings in the first stator 22a to cause the first rotor 24a to generate a torque and to rotate at synchronous speed, matching a rotational speed of the magnetic field generated by the windings in the first stator 22a.

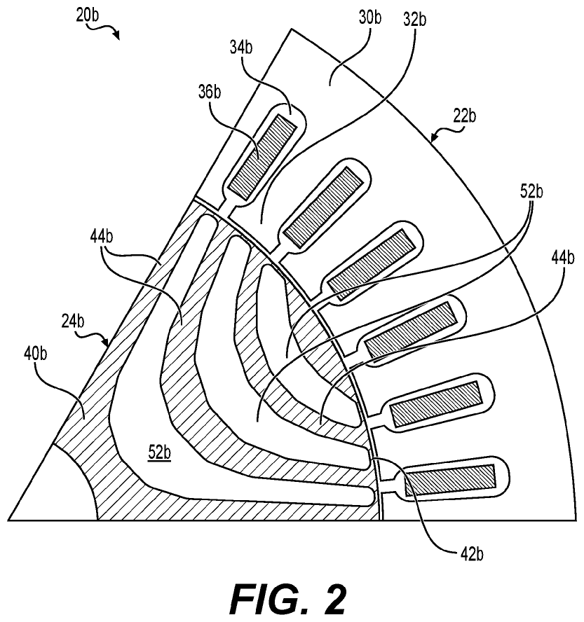

FIG. 2 shows a fragmentary cut-away side view of a second synchronous reluctance machine 20b. The second synchronous reluctance machine 20b may be similar or identical to the first synchronous reluctance machine 20a of FIG. 1, with a few exceptions described herein.

The second synchronous reluctance machine 20b includes a second stator 22b having a second stator core 30b, which may be made of metal laminations. The second stator core 30b defines a series of second teeth 32b at regular circumferential intervals, with each of the second teeth 32b extending radially inwardly and defining second slots 34b for receiving second stator windings 36b between adjacent ones of the second teeth 32b. Each of the second slots 34b includes one set of the second stator windings 36b. However, different winding arrangements may be used.

The second synchronous reluctance machine 20b also includes a second rotor 24b including a second rotor core 40b having a cylindrical shape defining a second peripheral edge 42b. The second rotor core 40b of the second rotor 24b defines a plurality of second arch-shaped structures 44b in several nested groups disposed at regular angular intervals. Only one of the nested groups of the second arch-shaped structures 44b is shown in the fragmentary view of FIG. 2. However, the second rotor core 40b of the second rotor 24b may include a number of the nested groups of the second arch-shaped structures 44b, such as four, six, or eight of the nested groups of the second arch-shaped structures 44b. Each of the second arch-shaped structures 44b has a continuous arching curve that extends radially inwardly from adjacent to the second peripheral edge 42b. The second rotor core 40b defines second arch-shaped recesses 52b between adjacent ones of the second arch-shaped structures 44b. Together, the second arch-shaped structures 44b and the second arch-shaped recesses 52b define a plurality of circumferentially-spaced regions having relatively low reluctance interspaced with regions having relatively high reluctance. These circumferentially-spaced regions having relatively low reluctance interspaced with regions having relatively high reluctance may interact with a magnetic field generated by windings in the second stator 22b to cause the second rotor 24b to generate a torque and to rotate at synchronous speed, matching a rotational speed of the magnetic field generated by the second stator windings 36b in the second stator 22b.

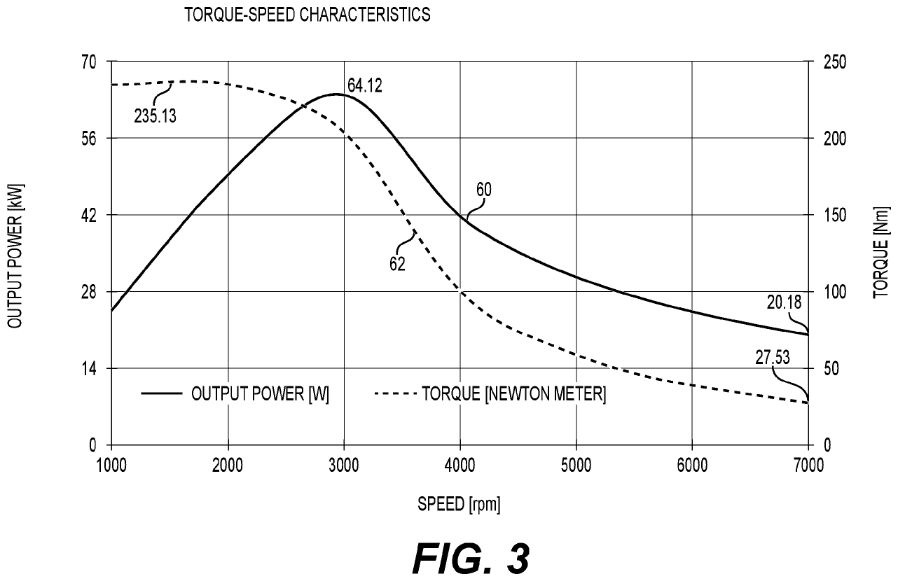

FIG. 3 shows a graph illustrating torque-speed characteristics of the second synchronous reluctance machine 20b. The graph of FIG. 3 includes a first plot 60 indicating output power in Kilowatts (KW) vs speed in revolutions per minute (RPM), and indicating a maximum output power of 64.12 kW at about 3000 RPM. The graph of FIG. 3 also includes a second plot 62 indicating output torque in Newton-Meters (Nm) vs speed in revolutions per minute (RPM), and indicating a maximum torque of 235.13 Nm that is relatively constant for speeds around and below about 2000 RPM.

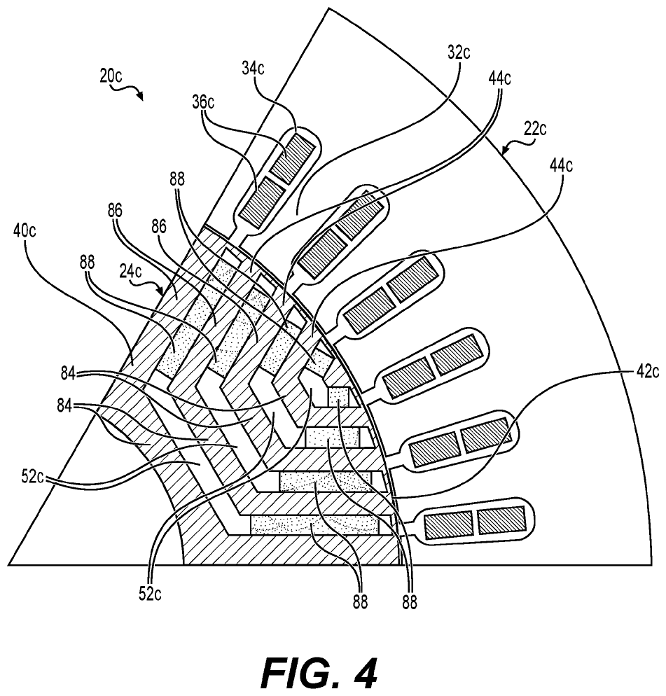

FIG. 4 shows a fragmentary cut-away side view of a third synchronous reluctance machine 20c. The third synchronous reluctance machine 20c may be similar or identical to the second synchronous reluctance machine 20b of FIG. 2, with a few exceptions described herein.

The third synchronous reluctance machine 20c includes a third stator 22c having a third stator core 30c, which may be made of metal laminations. The third stator core 30c defines a series of third teeth 32c at regular circumferential intervals, with each of the third teeth 32c extending radially inwardly and defining third slots 34c for receiving third stator windings 36c between adjacent ones of the third teeth 32c. Each of the third slots 34c includes two sets of the third stator windings 36c. However, different winding arrangements may be used.

The third synchronous reluctance machine 20c also includes a third rotor 24c including a third rotor core 40c having a cylindrical shape defining a third peripheral edge 42c. The third rotor core 40c of the third rotor 24c defines a plurality of third arch-shaped structures 44c in several nested groups disposed at regular angular intervals. Only one of the nested groups of the third arch-shaped structures 44c is shown in the fragmentary view of FIG. 2. However, the third rotor core 40c of the third rotor 24c may include a number of the nested groups of the third arch-shaped structures 44c, such as four, six, or eight of the nested groups of the third arch-shaped structures 44c. Each of the third arch-shaped structures 44c may be shaped similar or identical to the first arch-shaped structures 44a in the first synchronous reluctance machine 20a, with a flat center section 84. As shown, the flat center sections 84 extend in a generally annular orientation perpendicular to a radial line of the third rotor 24c. Each of the third arch-shaped structures 44c also includes two straight wing portions 86 each extending generally radially outwardly from respective ends of the flat center section 84. The third rotor core 40c also defines third arch-shaped recesses 52c between adjacent ones of the third arch-shaped structures 44c.

Together, the third arch-shaped structures 44c and the third arch-shaped recesses 52c define a plurality of circumferentially-spaced regions having relatively low reluctance interspaced with regions having relatively high reluctance. These circumferentially-spaced regions having relatively low reluctance interspaced with regions having relatively high reluctance may interact with a magnetic field generated by windings in the third stator 22c to cause the third rotor 24c to generate a torque and to rotate at synchronous speed, matching a rotational speed of the magnetic field generated by the windings in the third stator 22c.

The third rotor 24c also includes permanent magnets 88 are disposed within the third arch-shaped recesses 52c between the two straight wing portions 86 of the third arch-shaped structures 44c. In some embodiments, the permanent magnets 88 may include ferrite magnets. Alternatively or additionally, the permanent magnets 88 may include rare Earth material, such as Neodymium (Nd—Fe—B) and/or Samarium Cobalt (SmCo).

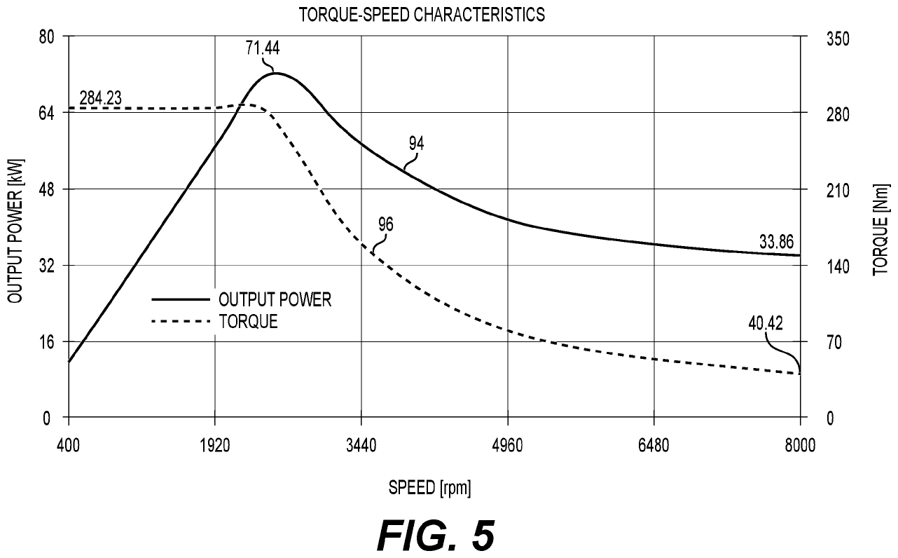

FIG. 5 shows a graph illustrating torque-speed characteristics of the third synchronous reluctance machine 20c. The graph of FIG. 5 includes a first plot 94 indicating output power in Kilowatts (kW) vs speed in revolutions per minute (RPM), and indicating a maximum output power of 71.44 kW at about 2500 RPM. The graph of FIG. 5 also includes a second plot 96 indicating output torque in Newton-Meters (Nm) vs speed in revolutions per minute (RPM), and indicating a maximum torque of 284.23 Nm that is relatively constant for speeds around and below about 2000 RPM.

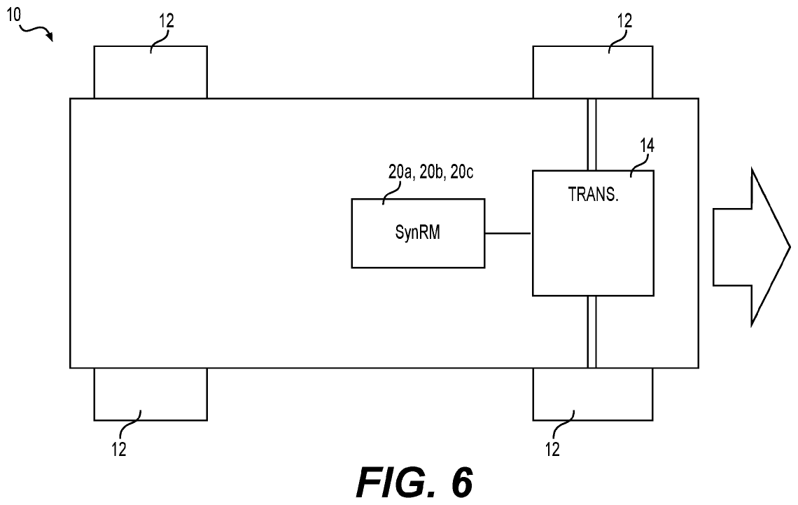

FIG. 6 shows a schematic block diagram of a vehicle 10 with a powertrain system including a synchronous reluctance machine 20a, 20b, 20c coupled to drive a set of wheels 12 via a transmission 14. The vehicle 10 of FIG. 6 is configured as a front-wheel drive, with the front two of the wheels 12 being driven by the synchronous reluctance machine 20a, 20b, 20c. However, the powertrain system and method of the present disclosure may be used with other configurations driving one or more wheels, such as a rear-wheel drive, an all-wheel drive, a four-wheel drive, etc. The vehicle 10 may be a passenger car or truck. The powertrain systems of the present disclosure may be used in other types of vehicles 10, such as motorbikes, commercial trucks, construction equipment, and/or agricultural equipment, such as tractors or other machines.

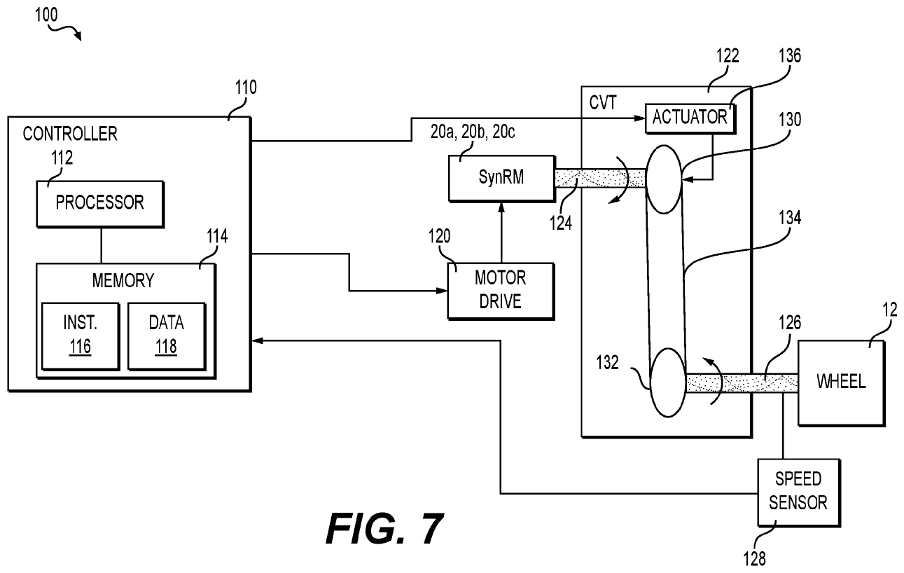

FIG. 7 shows a schematic block diagram of a first powertrain system 100 for providing traction power to propel a vehicle. The first powertrain system 100 includes a continuously variable transmission (CVT) 122 to provide a range of different gear ratios for coupling the synchronous reluctance machine 20a, 20b, 20c to drive one or more wheels 12.

The first powertrain system 100 includes a first controller 110 for controlling various functions. The first controller 110 may control operation of the CVT 122. For example, the first controller 110 may generate a CVT control signal for controlling a gear ratio of the CVT 122. In some embodiments, the first controller 110 may control may control other functions and/or components within the first powertrain system 100, such by sending a speed command to a motor drive 120 powering the synchronous reluctance machine 20a, 20b, 20c. The first controller 110 includes a first processor 112 coupled to a first storage memory 114. The first storage memory 114 includes a first instruction storage 116 storing instructions, such as program code for execution by the first processor 112. The first storage memory 114 also includes a first data storage 118 for holding data for use by the first processor 112. The first data storage 118 may record, for example, values of the parameters measured by one or more sensors and/or the outcome of functions calculated by the first processor 112.

The CVT 122 includes a first input shaft 124 that is rotated by the synchronous reluctance machine 20a, 20b, 20c, and a first output shaft 126 that drives one or more of the wheels 12. One or more other components, such as axles, differential gears, etc. may be connected in a torque-transferring path with the CVT 122 and are not shown on this drawing. The CVT 122 provides an adjustable gear ratio between the first input shaft 124 and the first output shaft 126. The first powertrain system 100 also includes a speed sensor 128 that measures a rotational speed of the first output shaft 126 or a rotational speed of the wheel 12 that is connected to the first output shaft 126, and which communicates that measured speed to the first controller 110.

The CVT includes an input pulley 130 coupled to rotate with the first input shaft 124 and an output pulley 132 coupled to rotate with the first output shaft 126. A belt 134 couples the input pulley 130 with the output pulley 132 and adjusts a gear ratio therebetween. An actuator 136 moves the belt 134 to adjust the gear ratio between the input pulley 130 and the output pulley 132 through a continuous range of values, thereby adjusting the gear ratio between the first input shaft 124 and the first output shaft 126. The actuator 136 may be in functional communication with the first controller 110 and configured to adjust the gear ratio in response to a command from the first controller 110.

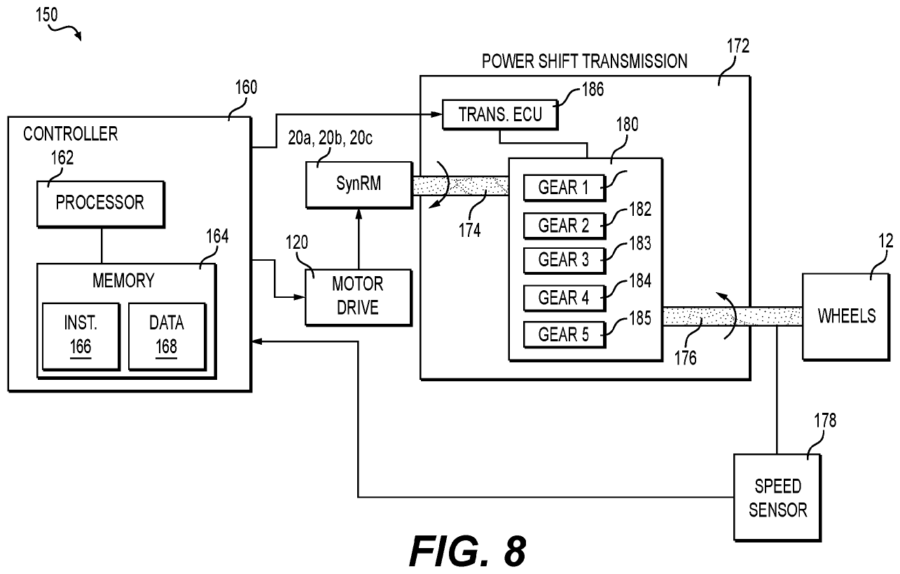

FIG. 8 shows a schematic block diagram of a second powertrain system 150 including a multi-geared transmission 172 to provide a plurality of different gear ratios for coupling the synchronous reluctance machine 20a, 20b, 20c to drive one or more wheels 12. The second powertrain system 150 may be similar to the first powertrain system 100, except with the multi-geared transmission 172 instead of the CVT 122 of the first powertrain system 100. In some embodiments, the multi-geared transmission 172 may be configured as a power shift transmission that is configured to continuously transmit torque while shifting between two different gears providing different gear ratios. For example, the multi-geared transmission 172 may be configured as a dual-clutch transmission having two clutches each providing some amount of slip while shifting between two different gears. However, the multi-geared transmission 172 may include other configurations, such as a conventional automatic transmission having a plurality of gears each providing a corresponding fixed gear ratio.

The second powertrain system 150 includes a second controller 160 for controlling various functions. The second controller 160 may control operation of the multi-geared transmission 172. For example, the second controller 160 may generate a gear selection signal for controlling a gear ratio of the multi-geared transmission 172. In some embodiments, the second controller 160 may control may control other functions and/or components within the second powertrain system 150, such by sending a speed command to a motor drive 120 powering the synchronous reluctance machine 20a, 20b, 20c. The second controller 160 includes a second processor 162 coupled to a second storage memory 164. The second storage memory 164 includes a second instruction storage 166 storing instructions, such as program code for execution by the second processor 162. The second storage memory 164 also includes a second data storage 168 for holding data for use by the second processor 162. The second data storage 168 may record, for example, values of the parameters measured by one or more sensors and/or the outcome of functions calculated by the second processor 162.

The multi-geared transmission 172 includes a second input shaft 174 that is rotated by the synchronous reluctance machine 20a, 20b, 20c, and a second output shaft 176 that drives one or more of the wheels 12. One or more other components, such as axles, differential gears, etc. may be connected in a torque-transferring path with the multi-geared transmission 172 and are not shown on this drawing. The multi-geared transmission 172 includes a gearbox 180 with a plurality of different gears 181, 182, 183, 184, 185, each providing a different gear ratio between the second input shaft 174 and the second output shaft 176. The gearbox 180 may include any discrete number of two or more gears, such as two gears, three gears, four gears, five gears, six gears, eight gears, ten gears, etc. The multi-geared transmission 172 also includes a transmission electronic control unit (trans. ECU) 186 configured to control selection of a given one of the different gears 181, 182, 183, 184, 185 at any given time. In some embodiments, the trans. ECU 186 is coupled to a plurality of different actuators, which may include solenoid valves, clutches, etc. to facilitate use of one of the plurality of different gears 181, 182, 183, 184, 185 in transmitting torque between the second input shaft 174 and the second output shaft 176 with a corresponding gear ratio therebetween. The trans. ECU may select one of the different gears 181, 182, 183, 184, 185 in response to a gear selection command from the second controller 160.

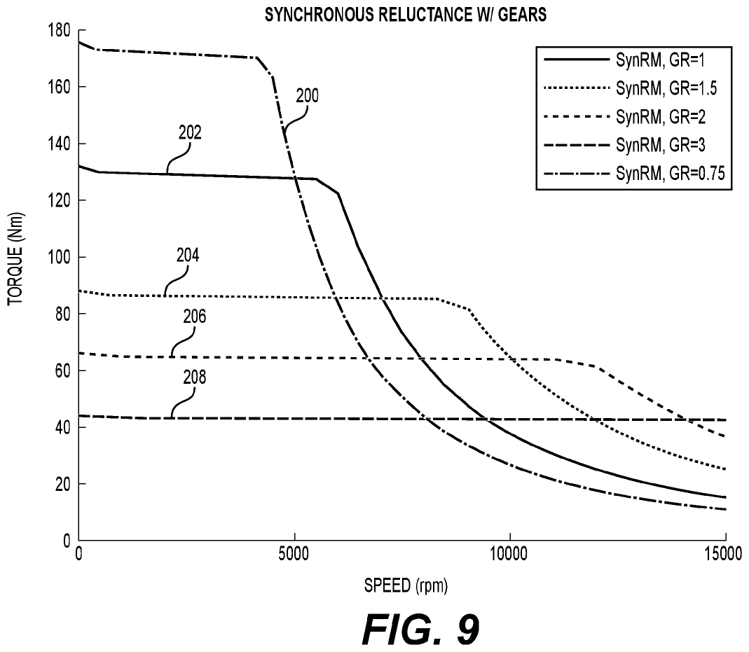

FIG. 9 shows a graph illustrating torque-speed characteristics of a powertrain system including a synchronous reluctance machine 20a, 20b, 20c coupled to the multi-geared transmission 172. The graph of FIG. 9 includes several plots of torque (Nm) vs. speed (RPM), including: a first plot 200 representing torque vs. speed for the first gear 181 having a gear ratio (GR) of 0.75, a second plot 202 representing torque vs. speed for the second gear 182 having a gear ratio (GR) of 1.0, a third plot 204 representing torque vs. speed for the third gear 183 having a gear ratio (GR) of 1.5, a fourth plot 206 representing torque vs. speed for the fourth gear 184 having a gear ratio (GR) of 2.0, and a fifth plot 208 representing torque vs. speed for the fifth gear 185 having a gear ratio (GR) of 3.0. The gear ratio values in the legend may be scaled to be a factor of the original fixed gear ratio. It is evident from the equations above and the plotted characteristics that values below one provide an increased torque capability at lower speeds. In contrast, values greater than one reduce the torque output but allow the machine to extend the constant torque region to higher speeds. With a discrete number of ratios there are steps in the operating envelope of the system. The system and method of the present disclosure may use a gear box providing any discrete number of two or more different gear ratios. For example, the system and method of the present disclosure may be implemented using the gearbox 180 having two gears, three gears, four gears, five gears, six gears, eight gears, ten gears, etc.

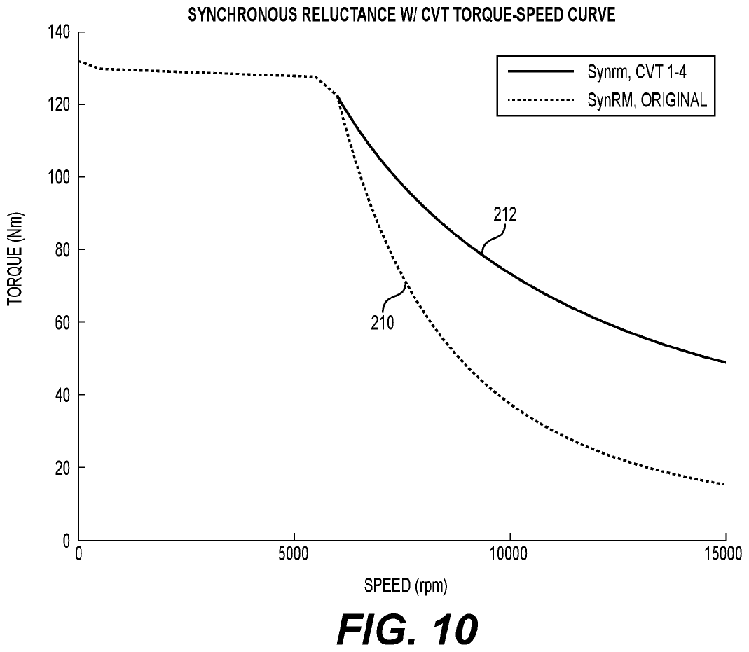

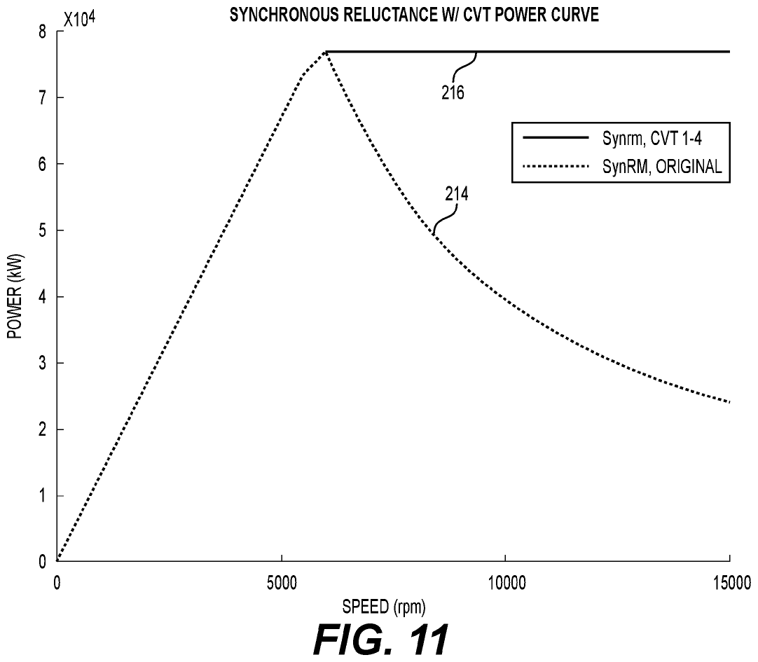

In a CVT system that is controlled by pulleys, there may be an infinite number of ratios that can be applied rather than having fixed steps. By analyzing the infinite possibilities of ratios and determining the torque-speed envelope of all combinations, the characteristic below is achieved. FIGS. 10-11 show that a CVT system can provide a constant power output for such a machine. This allows the machine to achieve higher torque output during high-speed operating conditions in comparison to the original fixed gear transmission scenario. A CVT system offers an enhanced characteristic in comparison to a multi-gear transmission system that uses 2 or 3 discrete ratios, but the cost of a CVT system is significantly larger than that of a multi-geared system. Therefore, as a compromise between performance and cost, a multi-gear system design can be optimized to achieve the desired operating characteristic.

FIG. 10 shows a graph illustrating torque-speed characteristics of a powertrain system including a synchronous reluctance machine 20a, 20b, 20c coupled to the CVT 122. The graph of FIG. 10 includes plots of torque (Nm) vs. speed (RPM), including: a first plot 210 indicating torque vs. speed for a synchronous reluctance machine 20a, 20b, 20c, alone, and a second plot 212 indicating torque vs. speed obtained by a synchronous reluctance machine 20a, 20b, 20c in combination with the CVT 122 and controlled in accordance with the method of the present disclosure.

FIG. 11 shows a graph illustrating power-speed characteristics of a powertrain system including a synchronous reluctance machine 20a, 20b, 20c coupled to the CVT 122. The graph of FIG. 10 includes plots of power (kW) vs. speed (RPM), including: a first plot 214 indicating power vs. speed for a synchronous reluctance machine 20a, 20b, 20c, alone, and a second plot 216 indicating power vs. speed obtained by a synchronous reluctance machine 20a, 20b, 20c in combination with the CVT 122 and controlled in accordance with the method of the present disclosure.

The additional benefit to using a multi-gear or CVT system is that the machine operating condition can be modified by controlling different gear ratios to target high motor efficiency operating regions. For a given axle torque-speed operating condition, the operating point can be located on various parts of the machine's torque-speed map based on the gear ratio that is applied between the machine and axle. An electrical machine's efficiency tends to be highest around the base speed at moderate torque levels. Therefore, it is useful to apply a gear ratio that moves the operating condition towards this location of the efficiency map. The figure below shows the efficiency map of a SynRM. A random operating condition from the fixed gear ratio is highlighted in red. The curve represented in blue displays all of the possibilities to provide the same axle torque and speed at the different ratios available with a CVT system.

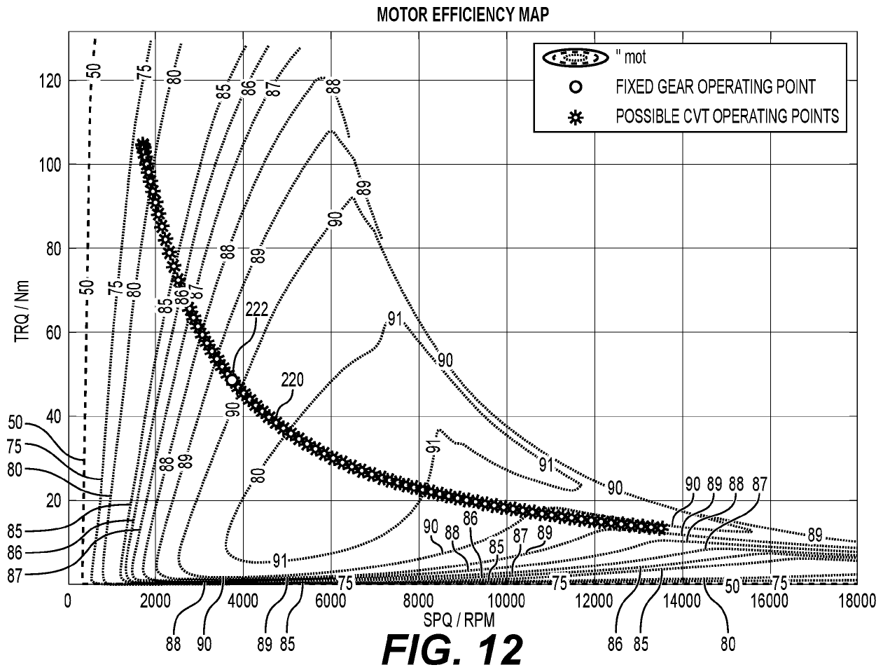

FIG. 12 shows a graph illustrating motor efficiency characteristics of a powertrain system including a synchronous reluctance machine 20a, 20b, 20c coupled to each of the multi-geared transmission 172 and the CVT 122. FIG. 12 includes plots of torque (Nm) vs. speed (RPM) including isobar lines indicating various different efficiencies of the powertrain system. The graph of FIG. 12 includes a plot 220 showing characteristics for a range of different operating points (i.e. gear ratios) of the CVT 122. A dot 222 indicates a fixed gear ratio operating point along the range of different operating points.

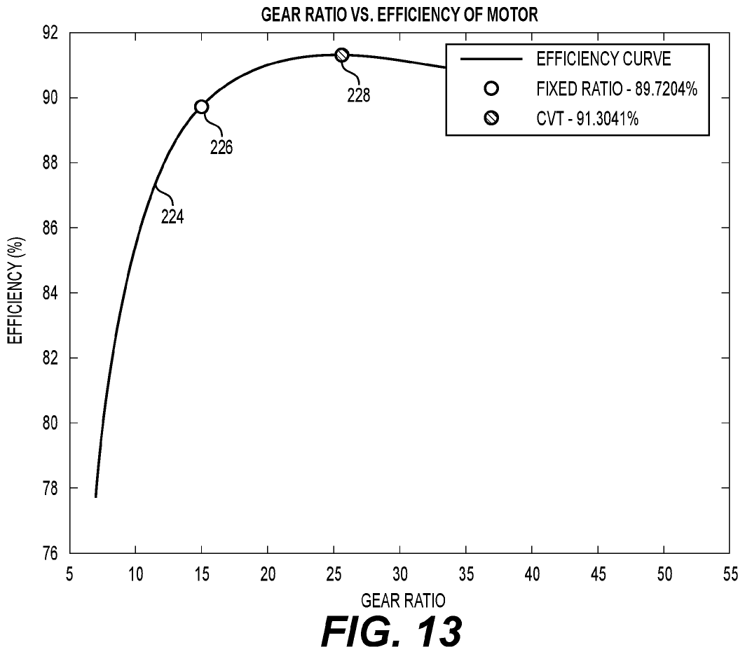

FIG. 13 shows a graph illustrating efficiency (%) as a function of gear ratio powertrain system including a synchronous reluctance machine 20a, 20b, 20c coupled to a transmission 122, 172. FIG. 13 includes a plot 224 indicating a range of different efficiencies for different gear ratios. FIG. 13 also includes a first dot 226 indicating a peak efficiency of 89.7204% for a fixed gear ratio obtainable by the multi-gear transmission 172, and a second dot 228 indicating a peak efficiency of 91.3041% for a gear ratio obtainable by the CVT 122. By increasing the gear ratio to the most optimally efficient point, the electric motor's efficiency can be raised by approximately 1.6% for this specific load condition. FIG. 13 provides an enhanced two-dimensional representation of the motor efficiency versus the applied gear ratio.

Applying this methodology to the entire drive-cycle of the machine can lead to a significant efficiency improvement. This feature enhances the SynRM drive-cycle efficiencies to be more competitive with the higher efficiency of PMSM drives. In comparison to a SynRM with a fixed gear ratio, the CVT could provide more driving range or a lower battery capacity requirement that could lead to cost savings. The methodology of the present disclosure can be applied to any type of synchronous reluctance machine, including permanent magnet assisted synchronous reluctance machines.

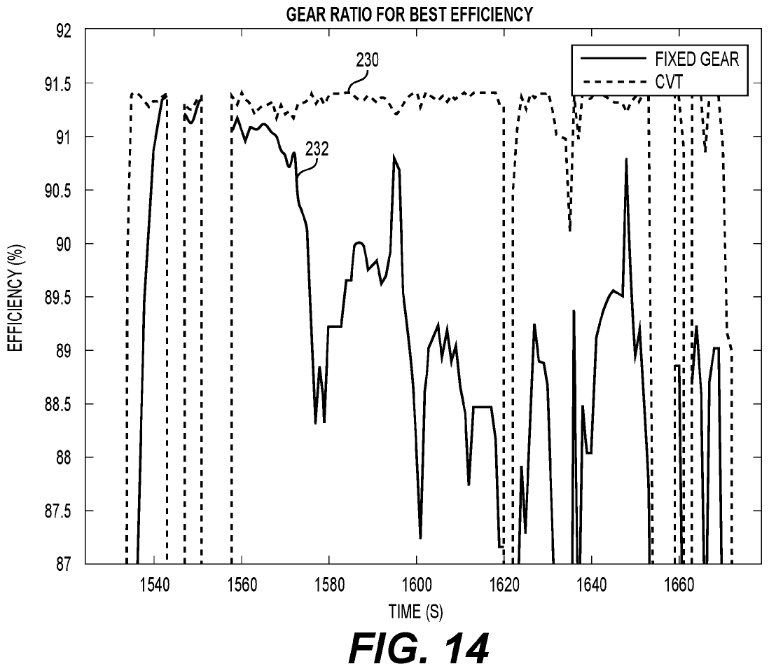

FIG. 14 shows a graph illustrating efficiencies (%) over time in a driving cycle and obtained by selecting gear ratios for gest efficiency in powertrain systems including a synchronous reluctance machine coupled to each of the multi-geared transmission 172 and the CVT 122. FIG. 14 includes a first plot 230 indicating efficiencies of the first powertrain system 100, which includes the continuously variable transmission (CVT) 122. FIG. 14 also includes a second plot 232 indicating efficiencies of the second powertrain system 150, which includes the multi-geared transmission 172.

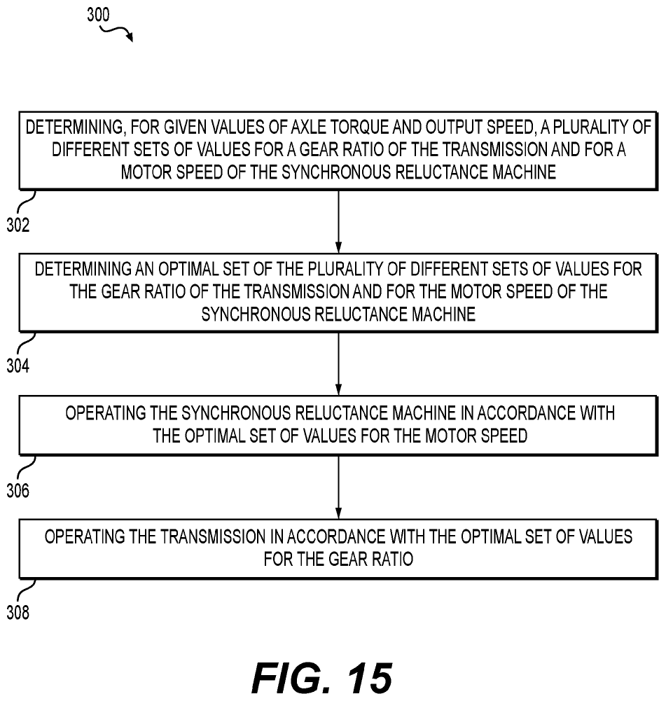

A method 300 for controlling a powertrain in a vehicle is shown in the flow chart of FIG. 15. More specifically, the method 300 describes steps in the method 300 for controlling a powertrain having a synchronous reluctance machine coupled to drive one or more wheels of the vehicle via a transmission. The method 300 can be performed by one or more electronic controllers, which may include one or more microprocessors or microcontrollers, in accordance with some embodiments of the present disclosure. As can be appreciated in light of the disclosure, the order of operation within the method is not limited to the sequential execution as illustrated in FIG. 15, but may be performed in one or more varying orders as applicable and in accordance with the present disclosure.

The method 300 includes determining, for given values of axle torque and output speed, a plurality of different sets of values for a gear ratio of the transmission and for motor speed of the synchronous reluctance machine at step 302. Step 302 may be performed, for example, by one of the controllers 110, 160.

The method 300 also includes determining an optimal set of the plurality of different sets of values for a gear ratio of the transmission and for motor speed of the synchronous reluctance machine at step 304. Step 304 may be performed, for example, by one of the controllers 110, 160.

The method 300 also includes operating the synchronous reluctance machine in accordance with the optimal set of values for the motor speed at step 306. For example, one of the controllers 110, 160 may generate and send a speed command the motor drive 120 to cause the motor drive to generate an alternating current (AC) power to cause the synchronous reluctance machine 20a, 20b, 20c to rotate its rotor at the motor speed in accordance with the optimal set of values.

The method 300 also includes operating the transmission in accordance with the optimal set of values for the gear ratio at step 308. Step 308 may be performed, for example, by one of the controllers 110, 160. For example, one of the controllers 110, 160 may generate and send a gear ratio command to the CVT 122 or a gear selection command to the multi-geared transmission 172.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for controlling a powertrain in a vehicle having a synchronous reluctance machine coupled to drive one or more wheels via a transmission, comprising:
determining, for given values of axle torque and output speed, a plurality of different sets of values for a gear ratio of the transmission and for a motor speed of the synchronous reluctance machine;
determining an optimal set of the plurality of different sets of values for the gear ratio of the transmission and for the motor speed of the synchronous reluctance machine;
operating the synchronous reluctance machine in accordance with the optimal set of values for the motor speed; and
operating the transmission in accordance with the optimal set of values for the gear ratio.

2. The method of claim 1, wherein the transmission includes a continuously variable transmission (CVT).

3. The method of claim 1, wherein the transmission is a multi-geared transmission including an input shaft, an output shaft, and plurality of gears, with each of the plurality of gears providing a fixed gear ratio between the input shaft and the output shaft.

4. The method of claim 3, wherein the transmission is configured to continuously transmit torque between the input shaft and the output shaft while shifting between two gears of the plurality of gears to provide a different gear ratio between the input shaft and the output shaft.

5. The method of claim 1, wherein the synchronous reluctance machine includes: a rotor having a rotor core defining a plurality of recesses, and a permanent magnet disposed in a recess of the plurality of recesses.

6. The method of claim 5, wherein the permanent magnet includes a ferrite magnet or the permanent magnet includes at least one of Neodymium (Nd—Fe—B) and Samarium Cobalt (SmCo).

7. The method of claim 1, wherein operating the synchronous reluctance machine in accordance with the optimal set of values for the motor speed includes generating and sending, by a controller, a speed command to a motor drive to supply an alternating current (AC) power to cause the synchronous reluctance machine to rotate a rotor thereof at the motor speed in accordance with the optimal set of values for the motor speed.

8. A powertrain system for a vehicle, comprising:
a synchronous reluctance machine having a rotor defining a plurality of circumferentially-spaced regions having relatively low reluctance interspaced with regions having relatively high reluctance;
a transmission operatively disposed between the synchronous reluctance machine and one or more wheels; and
a controller configured to:
determine, for given values of axle torque and output speed, a plurality of different sets of values for a gear ratio of the transmission and for a motor speed of the synchronous reluctance machine;
determine an optimal set of the plurality of different sets of values for the gear ratio of the transmission and for the motor speed of the synchronous reluctance machine; and
operate the synchronous reluctance machine and the transmission in accordance with the optimal set of values for the gear ratio of the transmission and for the motor speed of the synchronous reluctance machine.

9. The powertrain system of claim 8, wherein the transmission includes a continuously variable transmission (CVT).

10. The powertrain system of claim 8, wherein the transmission is a multi-geared transmission including an input shaft, an output shaft, and plurality of gears, with each of the plurality of gears providing a fixed gear ratio between the input shaft and the output shaft.

11. The powertrain system of claim 10, wherein the transmission is configured to continuously transmit torque between the input shaft and the output shaft while shifting between two gears of the plurality of gears to provide a different gear ratio between the input shaft and the output shaft.

12. The powertrain system of claim 8, wherein the rotor of the synchronous reluctance machine includes: a rotor core defining a plurality of recesses, and a permanent magnet disposed in a recess of the plurality of recesses.

13. The powertrain system of claim 12, wherein the permanent magnet includes a ferrite magnet.

14. The powertrain system of claim 12, wherein the permanent magnet includes at least one of Neodymium (Nd—Fe—B) and Samarium Cobalt (SmCo).

15. The powertrain system of claim 8, further comprising:
a motor drive configured to supply an alternating current (AC) power to the synchronous reluctance machine; and
wherein operating the synchronous reluctance machine in accordance with the optimal set of values for the motor speed includes generating and sending, by the controller, a speed command to the motor drive to cause the motor drive to generate the alternating current (AC) power to cause the synchronous reluctance machine to rotate the rotor at the motor speed in accordance with the optimal set of values for the motor speed.

16. The method of claim 5, wherein the permanent magnet includes a rare Earth material.

17. The method of claim 5, wherein each recess of the plurality of recesses includes: a flat center section that extends in a generally annular orientation, and two straight wing portions each extending generally radially outwardly from respective ends of the flat center section,
wherein the permanent magnet is disposed in one of the straight wing portions, and
wherein the permanent magnet does not extend through the flat center section.

18. The method of claim 17, further including another permanent magnet disposed in another one of the straight wing portions of each recess of the plurality of recesses.

19. The powertrain system of claim 12, wherein the permanent magnet includes a rare Earth material.

20. The powertrain system of claim 12, wherein each recess of the plurality of recesses includes: a flat center section that extends in a generally annular orientation, and two straight wing portions each extending generally radially outwardly from respective ends of the flat center section,
wherein the permanent magnet is disposed in one of the straight wing portions, and
wherein the permanent magnet does not extend through the flat center section.
